(19) United States
(12) Patent Application Publication
(10) Pub. No.: US 2016/0176630 A1
(43) Pub. Date: Jun. 23, 2016

(54) SMART GARBAGE BIN

(71) Applicant: ZAN Compute Inc., San Jose, CA (US)

(72) Inventor: Junaith Ahemed Shahabdeen, San Jose, CA (US)

(21) Appl. No.: 14/578,184

(22) Filed: Dec. 19, 2014

(51) Int. Cl. B65F 1/14; B65F 1/00

(52) U.S. Cl. CPC B65F 1/14; B65F 1/00

(57) ABSTRACT

A container (e.g., a garbage bin or document disposal bin) includes a sensor for sensing a quantity indicative of the amount of items deposited into the container, and a local controller capable of wireless communication with a remote controller for sending the sensed data to the remote controller. The sensor may be mounted on the cover or at the bottom of the container. The sensor placed on the cover may be a range finder that measures the distance between the container and its content. The sensor that is placed at the bottom of the container may be sensitive to the weight of the container and its contents. The sensor may be, for example, a reflective IR range finder, or a pressure sensor, such as a force sensing resistor. In addition, the sensed quantity may be the presence of a gaseous compound, such as hydrogen sulfide, ammonia and methane.

### BACKGROUND OF THE INVENTION

1. Field of the Invention

The present invention relates to a sensor-equipped garbage bin that indicates the used or unused level of its capacity and alerts conditions that require service.

2. Discussion of the Related Art

In existing janitorial services for commercial buildings, the process for managing garbage bins involves having facility workers manually inspect every garbage bin periodically during the day and provide cleanup when service is found needed during such inspections. The process for servicing the bins for document disposal, especially confidential documents, is similar, typically requiring a shredding service to periodically empty the bins.

### SUMMARY

According to one embodiment of the present invention, a container (e.g., a garbage bin or document disposal bin) includes a sensor for sensing a quantity indicative of the amount of items deposited into the container, and a local controller capable of wireless communication with a remote controller for sending the sensed data to the remote controller. The sensor may be mounted on the cover, or at the bottom of the container. The sensor placed on the cover may be a range finder that measures the distance between the container and its content. The sensor that is placed at the bottom of the container may be sensitive to the weight of the container and its contents. The sensor may be, for example, a reflective IR range finder, or a pressure sensor, such as a force sensing resistor. In addition, the sensed quantity may be the presence of a gaseous compound, such as hydrogen sulfide, ammonia and methane.

In one embodiment, upon detecting that the sensor reading exceeds a predetermined value, the local controller sends an alert to the remote controller. Upon detecting such a condition, the local controller may increase the rate at which the local controller activates the sensor. Otherwise, the local controller may decrease the rate at which the local controller activates the sensor.

According to one embodiment of the present invention, a garbage bin detects its own fullness (i.e., a level of garbage or other material contained in the bin), thereby eliminating the laborious process of having a service personnel to perform periodical checking. In another embodiment, the garbage bin may alert facility management or the cleaning crew, even though it is not full, when its content emits an unpleasant odor. The sensors in the garbage bin may include sensor specialized for various gases.

The present invention is better understood upon consideration of the detailed description that follows and the accompanying drawings.

### BRIEF DESCRIPTION OF THE DRAWINGS

FIG. 1 shows garbage bin 100, in which battery-operated sensor device 101 with wireless communication capability is provided on lid 102, in accordance with one embodiment of the present invention.

FIG. 2 shows sensor device 201, which is equipped with a pressure sensor at the bottom of garbage bin 200, in accordance with one embodiment of the present invention.

FIG. 3 is flow chart 300, which illustrates an algorithm that can be implemented in a software module being executed in a microprocessor to control a sensor-equipped garbage bin, in conjunction with one embodiment of the present invention.

### DETAILED DESCRIPTION OF THE PREFERRED EMBODIMENTS

The present invention provides a sensor-equipped garbage bin that reports its fullness and its physical condition. In one embodiment, the garbage bin sends an alert indicating that an immediate service (e.g., cleaning) is required. The garbage bin may be equipped with a number of types of sensors, such as those for detecting garbage level and presence of odors. In addition, the garbage bin may include a microprocessor for controlling data collection and a wireless radio transmitter for providing the collected data to a remote controller over wireless communication. The garbage bin finds a wide range of applications in facility management and waste management, such as automating janitorial services, and document disposal and shredding services. The garbage bins of the present invention may be used in conjunction with a facility management platform, such as that described in the co-pending patent application (“Smart Facility Management Application”) by the same inventor, entitled “Smart Facility Management Platform,” filed on the same day as the present application. The disclosure of the Smart Facility Management Application is hereby incorporated herein by reference in its entirety.

By combining sensors that allow various aspects of the environment within a garbage bin with wireless communication capability, such that the sensed data may be sent for processing and analysis by a remote server or controller, the present invention provides numerous unexpected advantages in both garbage bin technology and facility management. For example, sensed data from multiple sensors of different types can help formulate timely and energy-efficient, system-wide cleaning policies in a facility management system overseeing a large number of such garbage bins in multiple facilities. As the sensor devices of the present invention are battery operated, the embodiments of the present invention described herein, including the selected sensors, the data processing and communication hardware and the software for their control are designed to be power efficient.

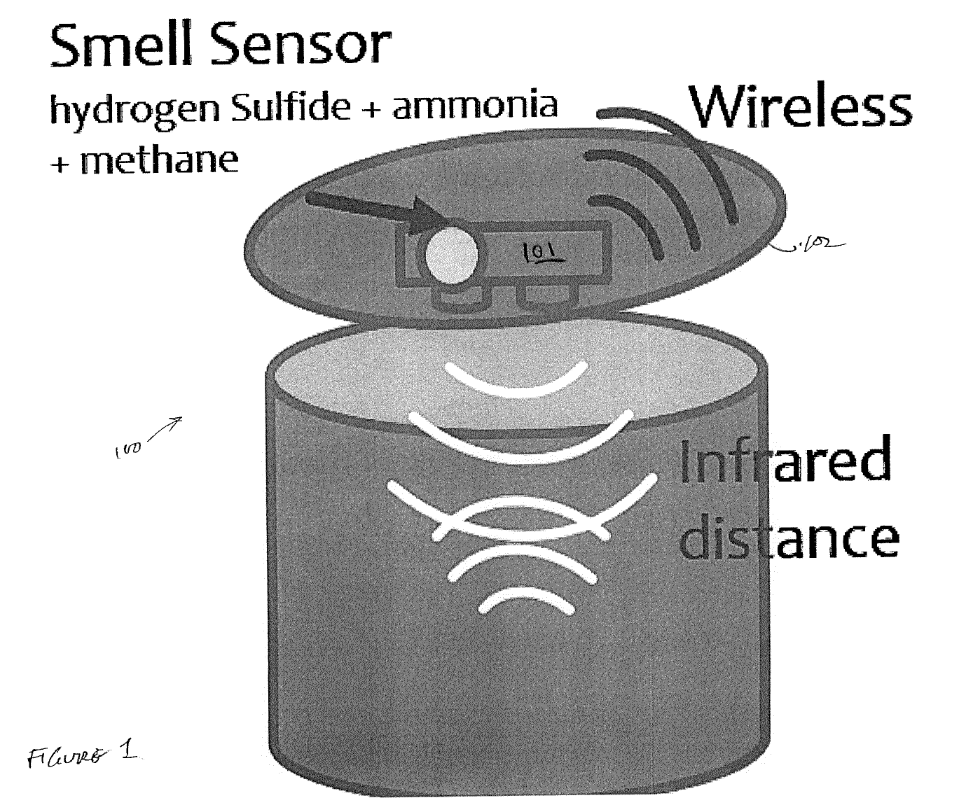

FIG. 1 shows garbage bin 100, in which battery-operated sensor device 101 with wireless communication capability is provided on cover or lid 102, in accordance with one embodiment of the present invention. To detect level of fullness of the content in the garbage bin, sensor device 101 may include a reflective infra-red (IR) range finder, such as the GP2Y0A41SK0F analog output type distance measuring sensor available from Sharp Corporation, Japan. As sensor device 101 is mounted on bin cover 102, the range finder detects the proximity of the garbage content in the bin (i.e., the distance between the top surface of the garbage pile to the sensor) as an indicator of the level of fullness in garbage bin 100. Typically, such a range finder uses the computed distance from the round-trip time (“time of flight”) between emitting an IR beam and receiving the reflected IR beam from the top surface of garbage pile. The principle of operation of such an IR reflection sensor is graphically illustrated in FIG. 1.

Several factors inform the selection of the IR range finder sensor, such as range and power. For example, the short range reflective IR sensor GP2Y0A41SK0F has a maximum range of up to one foot (1′) and dissipates a 5 mA current at a 5-volt power supply voltage. As most indoor garbage cans are not higher than three feet (3′), so that even in the case of the three-feet garbage bin, reflective IR sensor GP2Y0A41SK0F allows detecting the situation when the garbage bin is filled to the critical top ⅓^{rd} or ¼^{th} of the garbage bin. By forgoing detection to a greater range, the reflective IR sensor GP2Y0A41SK0F allows a power savings of 700% relative to existing state-of-the-art ultrasonic sensors. In one example, the ultrasonic sensor may dissipate a 35 mA current, and has a 20′-30′ range, which is an unnecessarily long range for the present application.

As shown in FIG. 1, sensor device 101 may include one or more sensors for sensing presence of certain undesirable gases in the garbage bin. Several pungent gases are known to be emitted from garbage dumps and bins. For example, the Center for Environmental Health, the Department of Health of New York State, has published an article, entitled “Important Things to Know about Landfill Gas” in which it points out that ammonia and hydrogen sulfide are the primary causes of the pungent smell of garbage bins. Some suitable sensors for detecting noxious gases include: (a) the MQ-136 sensor for detecting hydrogen sulfide, (b) the MQ-137 sensor for detecting ammonia and (c) the MQ-4 sensor for detecting methane. The MQ-136, MQ-137 and MQ-4 sensors are members of the MQ series semiconductor gas sensors available from Hanwei Electronics Co., Ltd., Zhengzhou, China. Based on the readings of these sensors, the presence of any unpleasant odors due to a sensed gas found to be emitting from a garbage bin may be reported and identified to facility mangers or supervisors. As a result, such an undesirable condition can be alerted to allow timely cleaning to be carried out. In some embodiments, as some of these sensors require greater power than is reasonable to be supplied from a battery; therefore, a sensing device for a garbage bin that incorporates these sensors may be powered from a wall outlet.

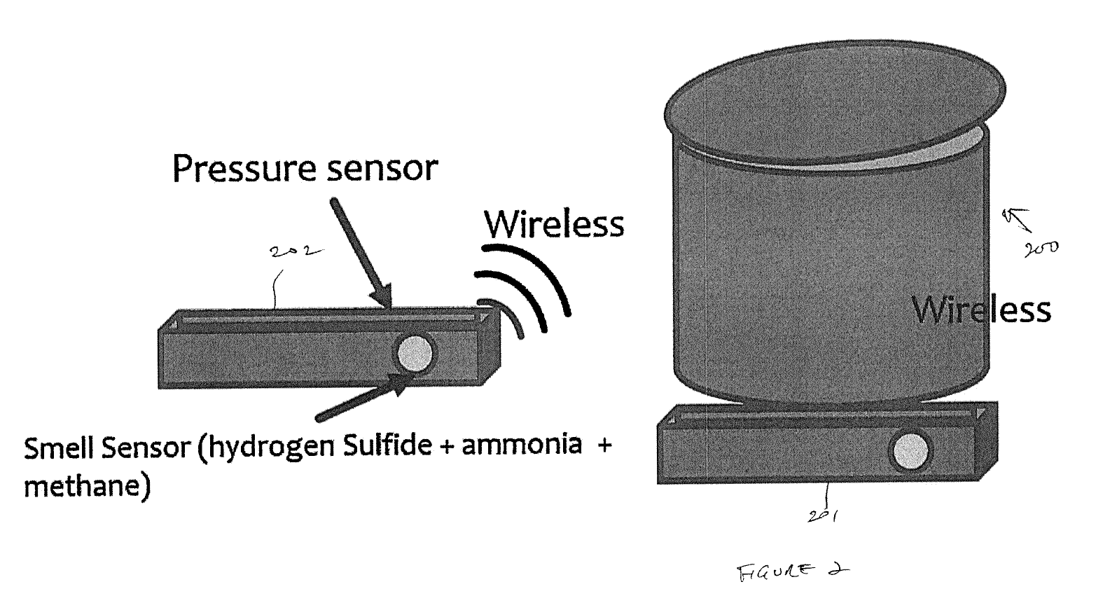

FIG. 2 shows sensor device 201, which is equipped with pressure sensor 202, provided at the bottom of garbage bin 200, in accordance with one embodiment of the present invention. Examples of suitable pressure sensors are provided, for example, in “Force Sensing Resistor (FSR) Integration Guide and Evaluation Parts Catalog,” available from Interlink Electronics, Inc., Camarillo, Calif. Sensor device 201 may be mounted below a regular garbage bin, or it may also be custom-built into a garbage bin. The pressure sensing device of sensor device 201 utilizes the change in total weight of garbage bin 200 to determine the garbage level. Sensor device 201 of garbage bin 200 is particularly suited for a garbage bin that is not provided with a top cover or lid (e.g., recycle bins, and those bins in office areas). In one embodiment, a FSR pressure sensor utilizes a change in resistance due to the additional weight to detect a change in garbage level. Similar to sensor device 101 of FIG. 1, sensor device 201 is also provided a microprocessor for local control and data processing and a wireless communication capability to allow it to transmit the sensed data to a remote controller for other data processing.

In one embodiment, a software module running on the microprocessor in sensor device 201 can be taught to subtract the weight of garbage bin 200 from the sensed data to provide the amount of garbage (in lbs) that is inside garbage bin 200. The software module may learn the weight of garbage bin 200 by observing the cycles of emptying. For example, a sudden drop in weight may be recognized as garbage emptying or cleaning up at garbage bin 200. Sensor device 201 tracks the maximum weight before cleanup cycles to adjust its calculation. The capacity of garbage bin 200 may also be programmed manually through a software interface. The software module may also be taught about a heavy object being dropped into garbage bin 200 by observing an abrupt increase in weight. In such a situation, the software module may be programmed to generate an event that reports the sudden increase in weight. Although the abrupt increase in weight does not convey that garbage bin 200 is full, an event reporting that a heavy object could have been placed in garbage bin 200 allows the facility managers to make an appropriate cleanup decision.

As in sensor device 101 of FIG. 1, sensor device 201 may include a number of gas sensors, such as those already discussed above.

In one embodiment, the software module running on the microprocessor in sensor device 101 of FIG. 1 or in sensor device 201 of FIG. 2 may be used to combine data from the sensors to generate cleanup events. Furthermore, the software module may also recognize trends from garbage build-up patterns over time to identify time periods during which the garbage bin is heavily used and those time periods during which the garbage bin is not heavily used. Based on the usage patterns identified, the software module may adjust data sampling rates to conserve battery power, without compromising its tracking ability. The software module is also responsible for putting to sleep and or waking up the wireless radio and the microprocessor, so as to conserve battery power.

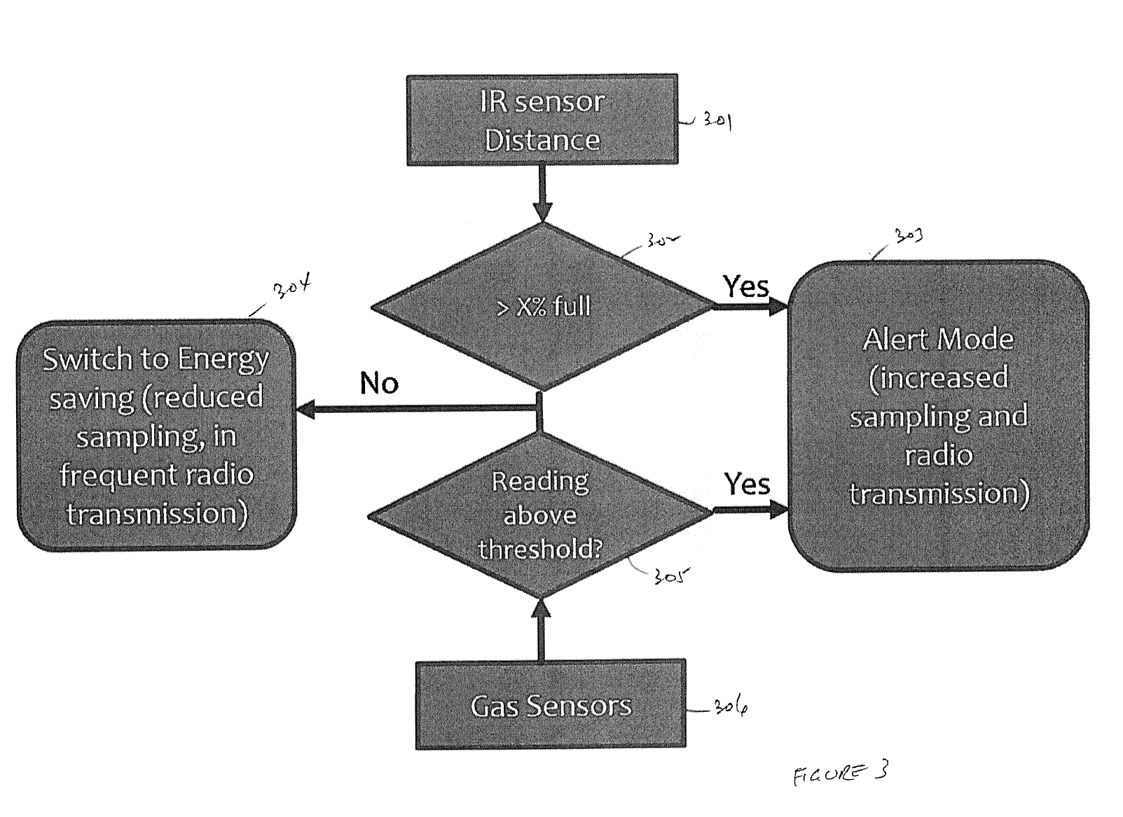

FIG. 3 is flow chart 300, which illustrates an algorithm that can be implemented in a software module being executed in a microprocessor to control a sensor-equipped garbage bin, in conjunction with one embodiment of the present invention. As shown in FIG. 3, at step 301, the reflective IR sensor is activated to make a measurement of the distance between the sensor and the top of the garbage pile. The software module then determines at step 302 whether or not the amount of garbage in the garbage bin exceeds a predetermined value. If so, at step 303, an alert is sent over wireless communication to a remote controller to report that the garbage bin may be due for service. At the same time, the data sampling rate for the reflective IR sensor (i.e., the frequency at which the reflective IR sensor is activated to measure the distance between the sensor and the top of the garbage pile) may be increased. If the reflective IR sensor measures a garbage level that is less than the predetermined value, the data sampling rate for the reflective IR sensor may be reduced (i.e., the reflective IR sensor may be activated less frequently) so as to reduce energy usage. Alternatively, a gas sensor may be activated at step 306 to detect the concentration of a gas for which the gas sensor is designed. The software module determines if the gas sensor's reading exceeds a predetermined threshold. If so, at step 303, an alert is sent over wireless communication to a remote controller to report that the garbage bin may be due for service. At the same time, the data sampling rate for the gas sensor (i.e., the frequency at which the gas sensor is activated) may be increased. If the gas sensor measures a gas concentration that is less than the predetermined threshold, the data sampling rate for the gas sensor may be reduced (i.e., the gas sensor may be activated less frequently) so as to reduce energy usage.

The above detailed description is provided to illustrate the specific embodiments of the present invention and is not intended to be limiting. Numerous modifications and variations of the present invention are possible. The present invention is set forth in the accompanying claims.

I claim:

1. A container, comprising:
a portion for holding items deposited into the container;
a sensor for sensing a quantity indicative of the amount of items deposited into the container; and
a local controller capable of wireless communication with a remote controller for sending the sensed data to the remote controller.

2. The container of claim 1, wherein the items deposited comprise garbage.

3. The container of claim 1, wherein the items deposited comprise documents.

4. The container of claim 1, further comprising a cover for the container, wherein the sensor is mounted on the cover.

5. The container of claim 4, wherein the quantity sensed is the distance between the sensor and one of the items deposited into the container.

6. The container of claim 5, wherein the sensor comprises a range finder.

7. The container of claim 5, wherein the sensor comprises a reflective IR range finder.

8. The container of claim 1, wherein the quantity sensed is a weight of the container together with the items deposited in the container.

9. The container of claim 8, wherein the sensor comprises a pressure sensor.

10. The container of claim 8, wherein the sensor comprises a force sensing resistor.

11. The container of claim 1, wherein the quantity sensed is a presence of a gaseous compound.

12. The container of claim 11, wherein the gaseous compound comprises one of: hydrogen sulfide, ammonia and methane.

13. The container of claim 1, wherein upon detecting that the quantity sensed exceeds a predetermined value, the local controller sends an alert to the remote controller.

14. The container of claim 13, wherein upon detecting that the quantity sensed exceeds a predetermined value, the local controller increases a rate at which the local controller activates the sensor.

15. The container of claim 13, wherein upon detecting that the quantity sensed does not exceed a predetermined value, the local controller decreases a rate at which the local controller activates the sensor.

16. The container of claim 1, wherein the wireless communication between the local controller and the remote controller is conducted using a light-weight communication protocol.

17. The container of claim 1, wherein the light-weight communication protocol comprises the MQTT protocol.
